(19) United States
(12) Patent Application Publication
(10) Pub. No.: US 2006/0275607 A1
(43) Pub. Date: Dec. 7, 2006

(54) Composite assemblies including powdered metal components

(76) Inventors: Semih Demir, London (CA); Mike Faroga, Kitchener (CA); Gerry Ward, Kitchener (CA); Jamie McPherson, Embro (CA)

Correspondence Address: John R. S. Orange;Blake, Cassels & Graydon LLP, Commerce Court West, Box 25, 199 Bay Street, Toronto, ON, M5L 1A9, CA

(21) Appl. No.: 11/144,790

(22) Filed: Jun. 6, 2005

(51) Int. Cl. B32B 9/00

(52) U.S. Cl. 428/408

(57) ABSTRACT

An assembly having a first component formed from a powdered metal, a second component formed from steel and connected to the first component by braze and a torque transmitting element welded to the second component.

### FIELD OF THE INVENTION

The present invention relates to methods of manufacturing assemblies incorporating powdered metal components and to such assemblies.

### DESCRIPTION OF THE PRIOR ART

Many parts used in mechanical devices have a complex shape. These may be made from a solid billet of steel by suitable machining although this is not usually an efficient use of material, particularly for high volume production. Alternatively the complex shape may be cast and subsequently machined to its finished dimension. This produces less waste but the casting process is both labour and energy intensive. It is also well known to utilise a powdered metal manufacturing process to make components of complex shapes. In such a process, a powder of iron and other additives is molded under pressure to produce a “green” component of a finished shape and then passed through a furnace where the green component is sintered. The finished components may have characteristics approaching those of wrought steel and have been widely used in many areas including power transmissions. The ability to mold the component to its near net shape minimises the wastage of material and increases the efficiency of production.

The use of powdered metal components, (PMC), in many applications is limited due to the geometry and design of these structural assemblies as well as the current state of development of equipment and process used in the manufacture of PMC. There are many torque transmitting components and assemblies that are made using a stamping, forging or casting processes and because PMC cannot readily be joined to wrought steel, this has limited the use of PMC in such applications. There are applications where a PMC is connected to a non PMC component using mechanical fasteners or capacitor discharge welding which either have limited application because of limited torque carrying capability or prohibitive because of increased production costs and complexity of manufacture.

In U.S. Pat. No. 3,717,442 there is disclosed a brazing alloy that permits a powdered metal component to be joined to a solid wrought substrate, such as steel, cast iron or the like. An improvement in that brazing alloy is disclosed in U.S. Pat. No. 4,029,476, which also notes some of the difficulties encountered with the brazing alloy of 3,717,442. In each of these references, it is proposed to braze the two components during the sintering of the powdered metal component. This subjects the wrought steel component to the elevated temperatures within the sintering surface that may lead to distortion and degradation of the properties of the steel. As such, the process described in the above patents is not considered suitable for the production of assemblies that utilise precision machined, highly loaded components together with powdered metal components.

It is therefore an object of the invention to obviate and mitigate the above disadvantages.

### SUMMARY OF THE INVENTION

In general terms, one aspect of the present invention provides an assembly in which a powdered metal component is brazed to steel substrate and a torque transmitting element is subsequently welded to the substrate.

Preferably the steel substrate has a carbon content greater than 12% and less than 45%, more preferably 18% to 26 % and most preferably 18%.

As a further preference, the torque transmitting element can be a shaft or a clutch mechanism or an annulus gear and is laser welded to the substrate.

In a further aspect of the invention there is provided a method of manufacturing an assembly including the steps of molding a component from powdered metal, supporting said component on a steel substrate, locating a brazing alloy between said steel substrate and said component, passing said component and substrate through a sintering furnace to sinter the said component and braze said substrate to said substrate and subsequently welding a torque transmitting element to said substrate.

Preferably, said method includes the step of laser welding the torque transmitting element.

### BRIEF DESCRIPTION OF THE DRAWINGS

An embodiment of the invention will now be described by way of example only with reference to the appended drawings wherein:

FIG. 1 is an exploded perspective view of a planetary gear carrier assembly,

FIG. 2 is a longitudinal section of the carrier assembly of FIG. 1,

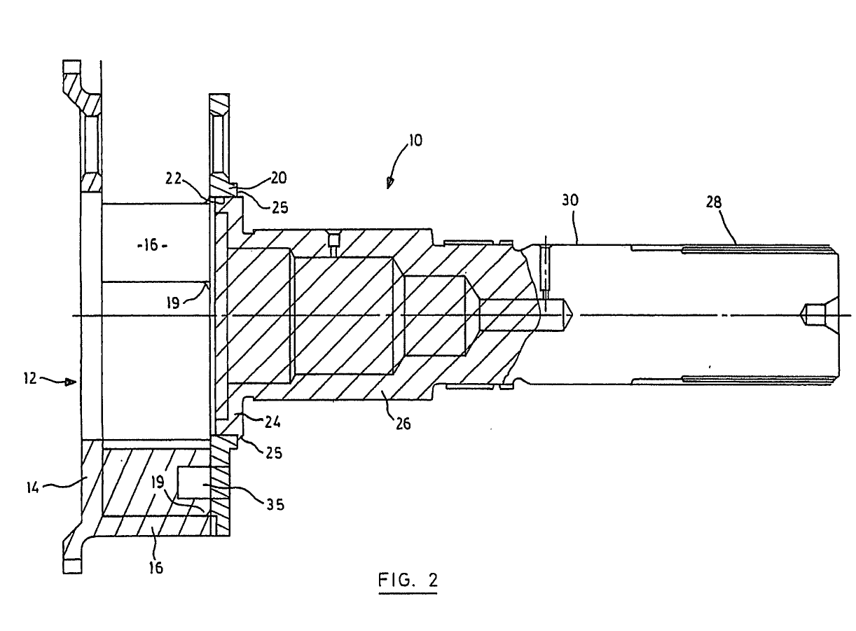

FIG. 3 is a schematic representation of the steps of producing the assembly of FIG. 2,

FIG. 4 is a detailed view of a portion of the carrier assembly shown in FIGS. 1 and 2,

FIG. 5 is a temperature profile of a sintering furnace used in the production of the assembly of FIG. 1.

### DETAILED DESCRIPTION OF THE INVENTION

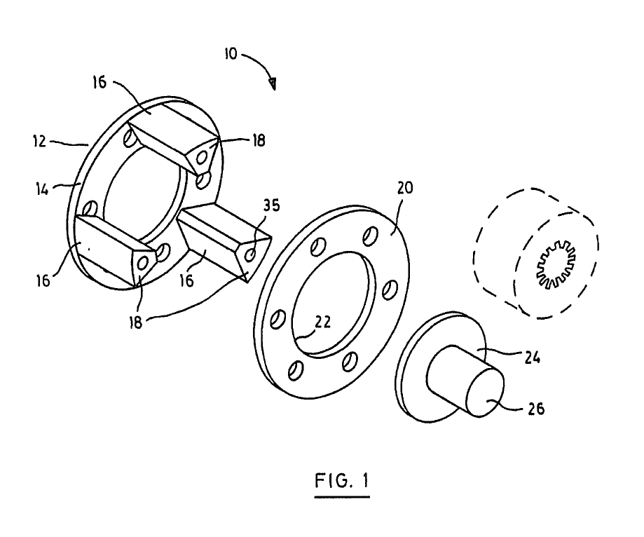

Referring therefore to FIG. 1, a planetary carrier assembly 10 includes a carrier 12 having a base 14. Legs 16 project from the base 14 at spaced intervals and terminate in end faces 18. The carrier 12 is molded from a powdered metal and, prior to sintering, is in a “green” state. The powder is a ferrous powder metal alloy, containing iron, copper, carbon and possible other alloying elements such as molybdenum, manganese, chromium, and nickel.

The carrier 12 is connected by braze, indicated at 19, to a substrate 20 stamped from rolled steel stock that has a relatively low carbon content, typically of ASTM1018 or ASTM1026 grade. Generally, the carbon content is between 12% and 45%, preferably between 18% and 26%. The higher carbon content is selected to provide adequate strength after annealing during the sintering process whilst retaining the weldability of the substrate.

The substrate 20 has a central aperture 22 that receives a boss 24 of a shaft 26. The boss 24 is laser welded about its periphery to the substrate 20 as indicated at 25. The shaft 26 is provided to transmit torque between the planetary carrier 12 and a drive member (not shown) and is machined from a steel blank of high tensile steel, such as ASTM 4130. Typically the shaft 26 can be hollow or solid and includes splines 28 on its outer surface for mating with the drive member and bearing surfaces 30 that support the shaft 26 in the drive member. The shaft 26 will typically be heat treated and partially machined to in-process dimensions prior to incorporation in the carrier assembly 10.

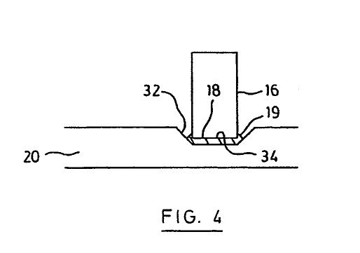

To facilitate the connection of the legs 16 to the substrate 20, a recess 32 is formed in the substrate at the location of each of the legs 16, as best seen in FIG. 4. The recess 32 has a depressed mating surface 34 directed toward the end face 18 of the leg 16. The mating surface 34 is roughened during or after stamping/coining operation to improve adhesion of the braze 19. The surface finish of the stamped steel substrate will typically have an average surface finish Ra of 0.001 mm max and peak to valley roughness Ry of 0.005 mm max. After roughening of the mating surface 34, the average roughness Ra will have a value typically of 0.005 mm and a peak to valley roughness Ry of between 0.015 and 0.080 mm.

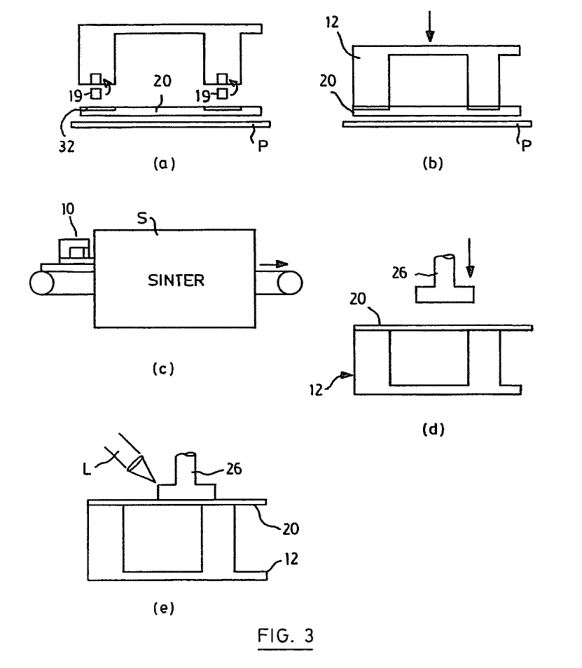

The steps of forming the planetary carrier assembly 10 are shown schematically in FIG. 3. Initially, the carrier 12 is molded to the required dimensions and the substrate 20 stamped from rolled steel stock. The mating surfaces 34 are roughened and the substrate 20 placed on a plate P. A pellet of braze 19 is placed in a pocket 35 formed in each of the end faces 18 of the legs 16 (FIG. 3a) and the “green” carrier 12 placed on the substrate so that each leg 16 is received in a respective recess 32 (FIG. 3b). The braze pellet 19 melts and forms the braze alloy, thereby welding the end face 18 and the mating surface 34.

The platen P is the fed through a sintering furnace S (FIG. 3c) which is maintained at an elevated temperature to sinter the green carrier 12 to a finished component. During the passage through the furnace S, the substrate 20 supports the carrier 12 in a stable manner to maintain the dimensional accuracy of the carrier 12. The substrate is itself elevated to the temperature of the furnace S causing a change in the grain structure. The microstructure of the substrate 20 changes from a fine pearlite to a coarser grain structure resulting in a reduction of yield strength and ultimate tensile strength. However, the higher carbon content used in the substrate maintains the physical properties of the substrate at levels comparable to a conventional non-annealed rolled steel, such as ASTM 1010 grade,

During passage through the furnace S, the brazing pellet 19 melts and is absorbed partially in to the porous structure of the leg 16 of the carrier 12. The mating surface 34 is not absorbent so the recess 32 acts to provide a pool of braze 19 for securing the leg 16 to the substrate 20. The rough surface texture of the substrate at location 34 is designed to optimize the wettability of mating surfaces and results in a robust brazed joint. As the platen P emerges from the furnace S, the braze 19 solidifies and physically secures the carrier 12 to the substrate 20.

The presence of a non absorbent mating surface and the orientation of the carrier in the furnace S permits a modified braze 19 to be used to enhance the load carrying capacity of the connection. A copper content of greater than 40% is used to provide better strength. Normally such a copper content would not be acceptable as the surface tension would be reduced and permit dissipation of the braze in to the body of the PMC. However, the impervious substrate located below the PMC reduces the absorption of the braze permitting the use of higher copper alloys that result in good surface coverage and weld. The preferred braze composition is as follows:

| | |
|---|---|
| Ni | 35.0% |
| Cu | 41.9% |
| Mn | 13.1% |
| B | 1.2% |
| Si | 1.5% |
| Fe | 7.3% |

After cooling and machining, the boss 24 of the shaft 26 is inserted in to the aperture 22 and laser welded about its periphery with a laser welding head L (FIG. 3d). The substrate 20 provides a weldable structure for attachment of the shaft 26 (or other torque transmitting element) and the laser welding provides localised heating to avoid distortion of the shaft 26. With the shaft 26 or the other torque transmitting element) secured, the planet carrier assembly is complete and ready for finish machining so that it can be fitted with planet gears for use in a power transmission a normal manner.

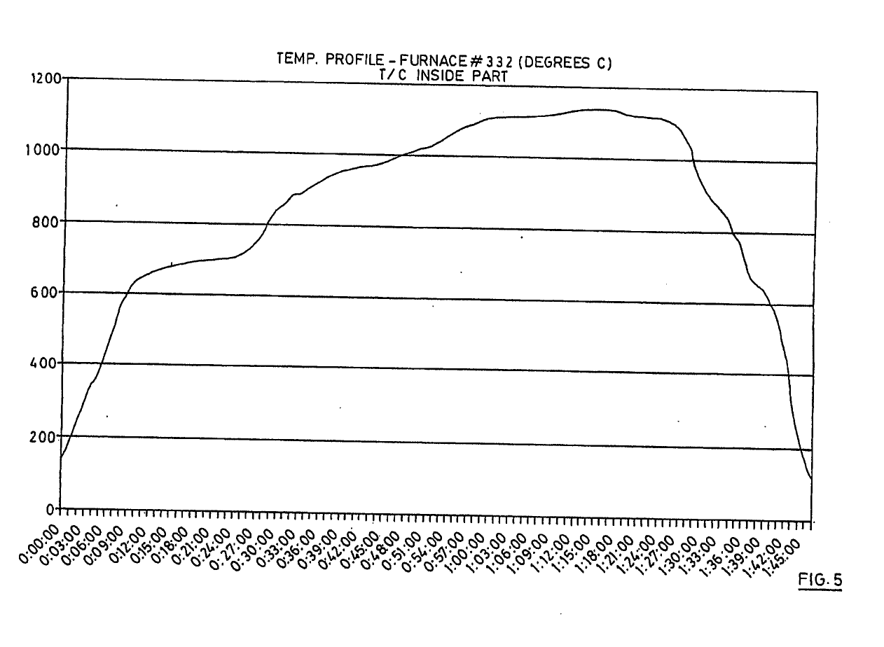

In exemplary testing, carrier assemblies were made using the process described above and subjected to fatigue testing. The sintering furnace S was a mesh belt conveyor furnace, such as those available from Drever, providing four heating zones as the platen P passes through the furnace. The temperature profile is shown in FIG. 5 and the temperature set in each zone shown in table 1 below:

| ZONE | MIN (deg C.) | MAX(deg C.) |
|---|---|---|
| 1 | 950 | 990 |
| 2 | 980 | 1020 |
| 3 | 1110 | 1150 |
| 4 | 1110 | 1150 |

The platen was moved through the furnace S at a rate of between 4.4 and 5.3 in/min and the total time to pass through the furnace was 2 hour 15 minutes.

In a first set of tests, the substrate 20 was stamped from 1018 rolled steel stock and the shaft 26 was made from 4130 steel. The shaft 26 was subjected to a reversing torque. The samples were tested to failure. For comparison, the same test was performed using a conventional stamped steel carrier rather than the PMC carrier. The results are shown in the table below:

| | TORQUE | | |
|---|---|---|---|
| TYPE | Ft-lb | CYCLES | OBSERVATIONS |
| STEEL | 2700 | 5000 | Large cracks and |
| | | | material failure at |
| | | | 5000 cycles |
| PMC | 2700 | 5000 | Minor cracks in steel |
| | | | and PM flange |
| | | | No failure at 5000 |
| | | | cycles |
| STEEL | 1100 | 450000 | Large cracks in legs, |
| | | | shaft flange, plate, |
| | | | welds |
| | | | Test stopped at |
| | | | 450,000 |
| PMC | 1100 | 500000 | Minor cracks on PM |
| | | | carrier |

In the above tests, superior performance was obtained for the PMC carrier as for a conventional stamped steel construction, indicating adequate performance.

It will be seen therefore that by providing a steel substrate it may be brazed to the PMC component and serve as a base for welding precision steel components. Although described in the production of a planetary carrier, it will be recognised that similar techniques may be used with other composite assemblies.

For example, an annulus gear with internal splines shown in ghosted outline if FIG. 1 may be fitted into the aperture 22 and welded to the substrate 20 to provide an alternative configuration of carrier.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

What is claimed is:

1. An assembly having a first component formed from a powdered metal, a second component formed from steel and connected to said first component by braze and a torque transmitting element welded to said second component.

2. An assembly according to claim 1 wherein said torque transmitting element is a shaft having a machined finish.

3. An assembly according to claim 1 wherein said second component is a rolled steel plate.

4. An assembly according to claim 3 wherein said plate has a carbon content of 12% or greater.

5. An assembly according to claim 4 wherein said carbon content is less than 45%.

6. An assembly according to claim 5 wherein said carbon content is between 18% and 26%.

7. An assembly according to claim 6 wherein said carbon content is 18%.

8. An assembly according to claim 3 wherein said plate has a plurality of recesses formed therein and projections from said first component are received in respective ones of said recesses to locate said first component relative to said second component.

9. An assembly according to claim 8 wherein said recess has a mating surface to receive said projections and said mating surface is roughened.

10. An assembly according to claim 8 wherein said braze is located in said recess.

11. An assembly according to claim 10 wherein said braze has a copper content greater than 40%.

12. A method of forming an assembly from a plurality of components in which one of said components is a powdered metal component and another is a steel component, said method comprising the steps of supporting said powdered metal component in a green state on said steel component, locating a brazing alloy between said components, passing said components through a sintering furnace to sinter said powdered metal component and melt said brazing alloy, cooling said components to solidify said brazing alloy and subsequently welding a torque transmitting element to said steel component, whereby a unitary structure is obtained.

13. A method according to claim 12 including the step of forming recesses in said steel component to receive projections from said powdered metal component.

14. A method according to claim 13 including the step of roughening a mating surface of said recess prior to locating said projections thereon.

15. A method according to claim 13 including the step of keeping said brazing alloy within said recesses after locating said projections therein and the sinter brazing operation.

16. A method according to claim 12 including the step of laser welding said torque transmitting element to said steel component.

17. A planetary carrier assembly having a carrier formed from powdered metal with a base and legs projecting from said base, a substrate formed from steel connected to the distal ends of said legs by brazing and a shaft welded to said substrate for transmission of torque.

18. A planetary carrier assembly according to claim 17 wherein said substrate is formed with recesses to receive respective ones of said legs and said brazing is located in said recess.

19. A planetary carrier assembly according to claim 18 wherein said substrate has a central aperture to receive said shaft and said shaft is welded to said substrate around the periphery of said aperture.

20. A planetary carrier according to claim 19 wherein said substrate has a carbon content greater than 12%.
